(19) United States
(12) Patent Application Publication
(10) Pub. No.: US 2012/0219790 A1
(43) Pub. Date: Aug. 30, 2012

(54) COMPOSTABLE FILM WITH PAPER-LIKE, WRITABLE SURFACE

(75) Inventors: Eldridge M. MOUNT, III, Canadaigua, NY (US); Deepali PALTA, Dallas, TX (US)

(73) Assignee: FRITO-LAY NORTH AMERICA, INC., Plano, TX (US)

(21) Appl. No.: 13/035,541

(22) Filed: Feb. 25, 2011

(51) Int. Cl. B32B 27/36; B32B 29/00

(52) U.S. Cl. 428/336; 428/480

(57) ABSTRACT

A multi-layer bio-based film with a paper-like, writable surface. In one aspect, the compostable bio-based film comprises a surface layer of a PHBV rich blend resin and an outer base layer of PLA or PHA.

### BACKGROUND OF THE INVENTION

1. Technical Field

The present invention relates to a compostable bio-based flexible packaging material that can be used in packaging products and to a method of making the bio-based packaging material. More specifically it relates to a method and composition for a compostable film with a paper-like, writable surface.

2. Description of Related Art

Multi-layered film structures made from petroleum-based products originating from fossil fuels are often used in flexible packages where there is a need for its advantageous barrier, sealant, and graphics-capability properties. Barrier properties in one or more layers are important in order to protect the product inside the package from light, oxygen or moisture. Such a need exists, for example, for the protection of foodstuffs, which may run the risk of flavor loss, staling, or spoilage if insufficient barrier properties are present to prevent transmission of such things as light, oxygen, or moisture into the package. The sealant properties are important in order to enable the flexible package to form an airtight or hermetic seal. Without a hermetic seal, any barrier properties provided by the film are ineffective against oxygen, moisture, or aroma transmission between the product in the package and the outside. A graphics capability is needed because it enables a consumer to quickly identify the product that he or she is seeking to purchase, allows food product manufacturers a way to label the nutritional content of the packaged food, and enables pricing information, such as bar codes, to be placed on the product.

One prior art multi-layer or composite film used for packaging potato chips and like products is illustrated in FIG. 1 which is a schematic of a cross section of the multi-layer film 100 illustrating each individual substantive layer. Each of these layers functions in some way to provide the needed barrier (layer 118), sealant (layer 119), and graphics capability properties. The graphics layer 114 is typically used for the presentation of graphics that can be reverse-printed and viewed through a transparent outer base layer 112. Like numerals are used throughout this description to describe similar or identical parts, unless otherwise indicated. The outer base layer 112 is typically oriented polypropylene (“OPP”) or polyethylene terephthalate (“PET”). A metal layer disposed upon an inner base layer 118 provides the required barrier properties. It has been found and is well-known in the prior art that metalizing a petroleum-based polyolefin such as OPP or PET reduces the moisture and oxygen transmission through the film by approximately three orders of magnitude. Petroleum-based OPP is typically utilized for base layers 112, 118 because of its lower cost. A sealant layer 119 disposed upon the OPP layer 118 enables a hermetic seal to be formed at a temperature lower than the melt temperature of the OPP. A lower melting point sealant layer 119 is desirable because melting the metalized OPP to form a seal could have an adverse effect on the barrier properties. Typical prior art sealant layers 119 include an ethylene-propylene co-polymer and an ethylene-propylene-butene-1 ter-polymer. A glue or laminate layer 115, typically a polyethylene extrusion, is required to adhere the outer base layer 112 with the inner, product-side base layer 118. Thus, at least two base layers of petroleum-based polypropylene are typically required in a composite or multi-layered film.

Other materials used in packaging are typically petroleum-based materials such as polyester, polyolefin extrusions, adhesive laminates, and other such materials, or a layered combination of the above.

FIG. 2 demonstrates schematically the formation of material, in which the OPP layers 112, 118 of the packaging material are separately manufactured, then formed into the final material 100 on an extrusion laminator 200. The OPP layer 112 having graphics 114 previously applied by a known graphics application method such as flexographic or rotogravure is fed from roll 212 while OPP layer 118 is fed from roll 218. At the same time, resin for PE laminate layer 115 is fed into hopper 215a and through extruder 215b, where it will be heated to approximately 600° F. and extruded at die 215c as molten polyethylene 115. This molten polyethylene 115 is extruded at a rate that is congruent with the rate at which the petroleum-based OPP materials 112, 118 are fed, becoming sandwiched between these two materials. The layered material 100 then runs between chill drum 220 and nip roller 230, ensuring that it forms an even layer as it is cooled. The pressure between the laminator rollers is generally set in the range of 0.5 to 5 pounds per linear inch across the width of the material. The large chill drum 220 is made of stainless steel and is cooled to about 50-60° F., so that while the material is cooled quickly, no condensation is allowed to form. The smaller nip roller 230 is generally formed of rubber or another resilient material. Note that the layered material 100 remains in contact with the chill drum 220 for a period of time after it has passed through the rollers, to allow time for the resin to cool sufficiently. The material can then be wound into rolls (not specifically shown) for transport to the location where it will be used in packaging. Generally, it is economical to form the material as wide sheets that are then slit using thin slitter knives into the desired width as the material is rolled for shipping.

Once the material is formed and cut into desired widths, it can be loaded into a vertical form, fill, and seal machine to be used in packaging the many products that are packaged using this method. FIG. 3 shows an exemplary vertical form, fill, and seal machine that can be used to package snack foods, such as chips. This drawing is simplified, and does not show the cabinet and support structures that typically surround such a machine, but it demonstrates the working of the machine well. Packaging film 310 is taken from a roll 312 of film and passed through tensioners 314 that keep it taut. The film then passes over a former 316, which directs the film as it forms a vertical tube around a product delivery cylinder 318. This product delivery cylinder 318 normally has either a round or a somewhat oval cross-section. As the tube of packaging material is pulled downward by drive belts 320, the edges of the film are sealed along its length by a vertical sealer 322, forming a back seal 324. The machine then applies a pair of heat-sealing jaws 326 against the tube to form a transverse seal 328. This transverse seal 328 acts as the top seal on the bag 330 below the sealing jaws 326 and the bottom seal on the bag 332 being filled and formed above the jaws 326. After the transverse seal 328 has been formed, a cut is made across the sealed area to separate the finished bag 330 below the seal 328 from the partially completed bag 332 above the seal. The film tube is then pushed downward to draw out another package length. Before the sealing jaws form each transverse seal, the product to be packaged is dropped through the product delivery cylinder 318 and is held within the tube above the transverse seal 328.

Petroleum-based prior art flexible films comprise a relatively small part of the total waste stream produced when compared to other types of packaging. However, because petroleum films are environmentally stable, they have a relatively low rate of degradation. Consequently, such films can survive for long periods of time in a landfill. Another disadvantage of petroleum-based films is that they are made from oil, which many consider to be a limited, non-renewable resource. Consequently, a need exists for a biodegradable or compostable flexible film made from a renewable resource. In one embodiment, such film should be food safe and have the requisite barrier properties to store a low moisture shelf-stable food for an extended period of time without the product staling. The film should have the requisite sealable and coefficient of friction properties that enable it to be used on existing vertical form, fill, and seal machines.

### SUMMARY OF THE INVENTION

The present invention is directed towards a compostable bio-based flexible packaging film with a paper-like, writable surface that can be used in packaging products. The bio-based film comprises a surface layer of a polyhydroxybutyrate-valerate (“PHBV”) rich blend resin, an outer base layer of polylactide (“PLA”) or polyhydroxy-alkanoate (“PHA”), an adhesive layer and a product side layer with barrier properties.

Other aspects, embodiments and features of the invention will become apparent from the following detailed description of the invention when considered in conjunction with the accompanying figures. The accompanying figures are schematic and are not intended to be drawn to scale. In the figures, each identical, or substantially similar component that is illustrated in various figures is represented by a single numeral or notation. For purposes of clarity, not every component is labeled in every figure. Nor is every component of each embodiment of the invention shown where illustration is not necessary to allow those of ordinary skill in the art to understand the invention. All patent applications and patents incorporated herein by reference are incorporated by reference in their entirety. In case of conflict, the present specification, including definitions, will control.

### BRIEF DESCRIPTION OF THE FIGURES

The novel features believed characteristic of the invention are set forth in the appended claims. The invention itself, however, as well as a preferred mode of use, further objectives and advantages thereof, will be best understood by reference to the following detailed description of illustrative embodiments when read in conjunction with the accompanying figures, wherein:

FIG. 1 depicts a cross-section of an exemplary prior art packaging film;

FIG. 2 depicts the exemplary formation of a prior art packaging film;

FIG. 3 depicts a vertical form, fill, and seal machine that is known in the prior art;

FIG. 4A depicts a magnified schematic cross-section of a hybrid multi-layer packaging film made according to one embodiment of the invention; and

FIG. 4B depicts a magnified schematic cross-section of a bio-based biodegradable multi-layer packaging film made according to one embodiment of the invention.

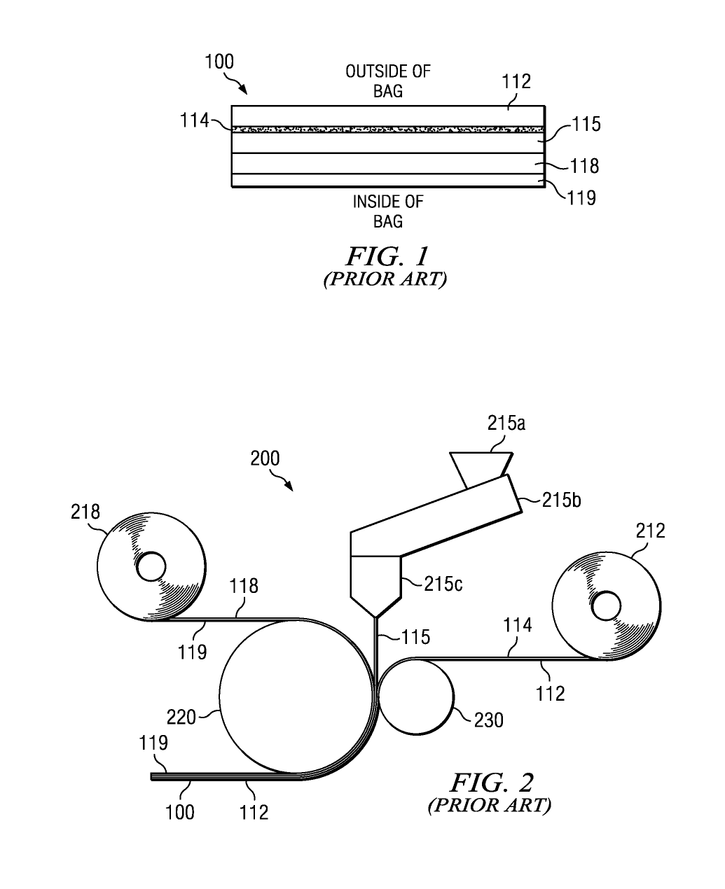

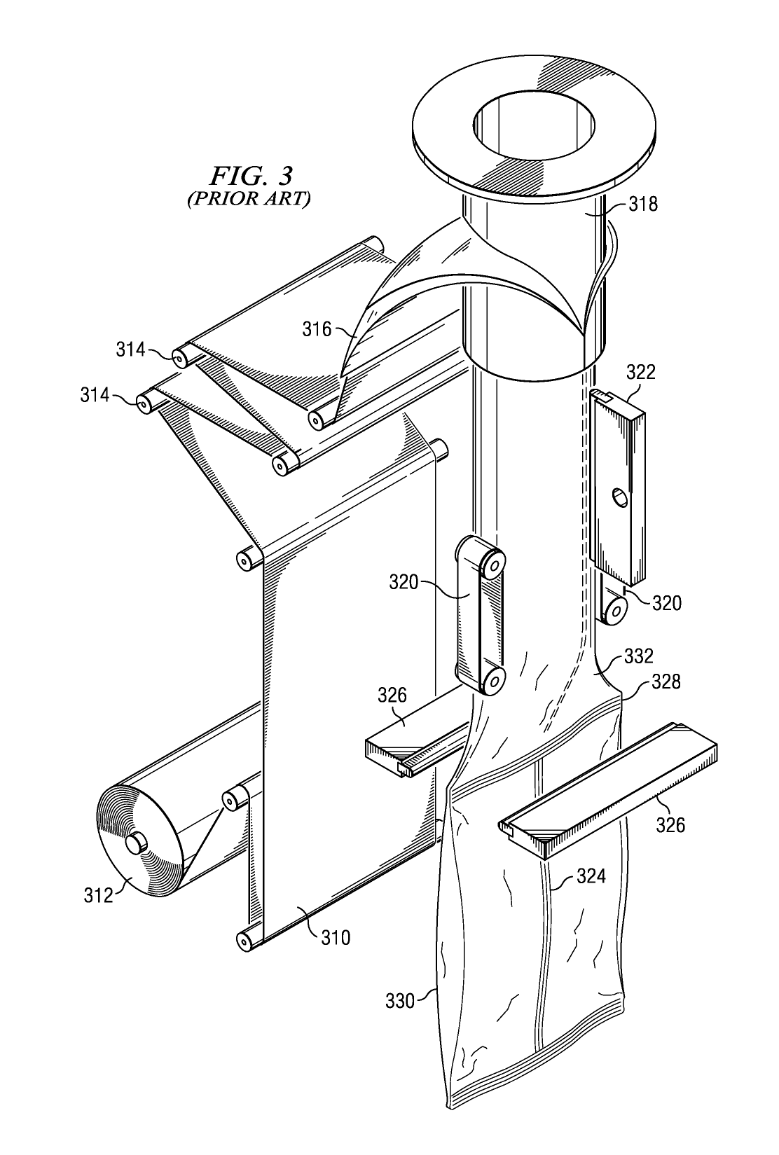

### DETAILED DESCRIPTION

The present invention is directed towards use of a bio-based film as at least one of the film layers in a multi-layer flexible film packaging with a matte, paper-like surface. As used herein, the term “bio-based film” means a polymer film where at least 80% of the polymer film by weight is derived from a non-petroleum or biorenewable feedstock. In one embodiment, up to about 20% of the bio-based film can comprise a conventional polymer sourced from petroleum.

One problem with PLA plastic films is that such films have poor moisture barrier and oxygen barrier properties. As a result, such films cannot currently be used exclusively in packaging. Further, many compostable films including PLA are brittle and stiffer than the OPP typically used for flexible film packages. The handling of open containers, such as grocery bags where no barrier is necessary, made exclusively from compostable films, is therefore relatively noisy as compared to prior art petroleum-based films. However, the inventors have discovered that many of these problems can minimized or eliminated by using a “hybrid” film.

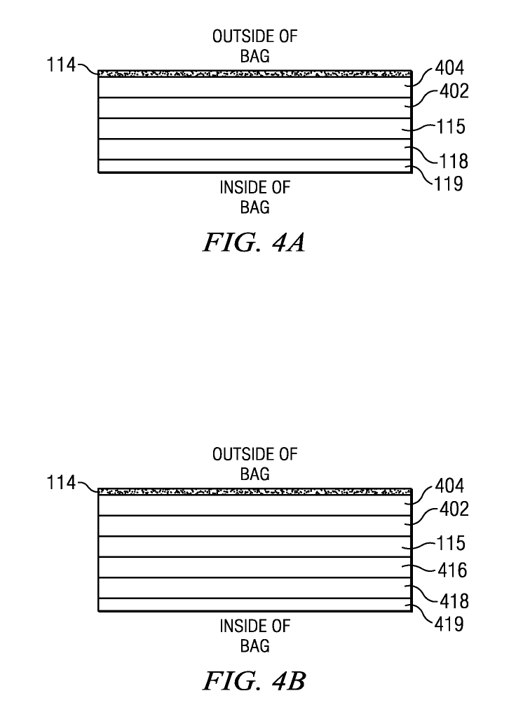

FIG. 4A depicts a magnified schematic cross-section of a hybrid multi-layer packaging film made according to one embodiment of the invention. Here, the outer transparent base layer comprises a biodegradable, bio-based film 402 in place of an oriented petroleum-based polypropylene 112 depicted in FIG. 1.

In one embodiment, the biodegradable, bio-based film 402 comprises polylactic acid, also known as polylactide (“PLA”), which is a compostable, thermoplastic, aliphatic polyester derived from lactic acid. PLA can be easily produced in a high molecular weight form through ring-opening polymerization of lactide/lactic acid to PLA by use of a catalyst and heat.

PLA can be made from plant-based feedstocks including soybeans, as illustrated by U.S. Patent Application Publication Number 2004/0229327 or from the fermentation of agricultural by-products such as corn starch or other plant-based feedstocks such as corn, wheat, or sugar beets. PLA can be processed like most thermoplastic polymers into a film. PLA has physical properties similar to PET and has excellent clarity. PLA films are described in U.S. Pat. No. 6,207,792 and PLA resins are available from Natureworks LLC (http://www.natureworksllc.com) of Minnetonka, Minn. PLA degrades into carbon dioxide and water at temperatures above its glass transition temperature. In one embodiment, the bio-based film layer comprises at least about 90% polylactic acid.

In one embodiment, the biodegradable, bio-based film 402 comprises polyhydroxy-alkanoate (“PHA”), available from Archer Daniels Midland of Decatur, Ill. PHA is a polymer belonging to the polyesters class and can be produced by microorganisms (e.g. Alcaligenes eutrophus) as a form of energy storage. In one embodiment, microbial biosynthesis of PHA starts with the condensation of two molecules of acetyl-CoA to give acetoacetyl-CoA which is subsequently reduced to hydroxybutyryl-CoA. Hydroxybutyryl-CoA is then used as a monomer to polymerize PHB, the most common type of PHA.

The laminate film depicted in FIG. 4A can be made by extruding a biodegradable, bio-based film 402 into a film sheet. In one embodiment, the bio-based film 402 has been oriented in the machine direction or the transverse direction. In one embodiment, the bio-based film 402 comprises a biaxially oriented film. In one embodiment, a 120 gauge bio-based film 402 is made. A biaxially oriented polyhydroxybutyrate-valerate (“PHBV”) rich blend film can be coextruded onto the surface of the bio-based film 402 to form a surface layer 404 upon which graphics may be printed by a known graphics application method to form a graphics layer 114. The bio-based film 402 can then be “glued” to the product-side metalized OPP film 118, by a laminate layer 115, typically a polyethylene extrusion. Alternatively, the bio-based film 402 can be extrusion laminated or adhesive laminated onto a paper layer (not shown). The paper layer can comprise any paper used for multi-layer product packages known in the art. Thus, the prior art OPP outer base layer 112 is replaced with a biodegradable and biorenewable outer base layer 402. In one embodiment, the outer base layer comprises PLA film 402 comprising multiple layers to enhance printing and coefficient of friction properties. In one embodiment, the PLA film 402 comprises one or more layers of PLA.

In the embodiment shown in FIG. 4A, the inside sealant layer 119 can be folded over and then sealed on itself to form a tube having a fin seal for a backseal. The fin seal is accomplished by the application of heat and pressure to the film. Alternatively, a thermal stripe can be provided on the requisite portion of the bio-based film 402 to permit a lap seal to be used.

Examples of metalized OPP films 118 having a sealant layer 119 that can be used in accordance with the present invention include PWX-2, PWX-4, PWS-2 films available from Toray Plastics of North Kingstown, R.I. or MU-842, Met HB, or METALLYTE films available from Exxon-Mobil Chemical.

The laminate of film depicted in FIG. 4A is a hybrid film because it comprises both a biodegradable, bio-renewable film 402 and a stable, metalized OPP film 118. However, one benefit of the present invention is that the outer PLA film 402 can be made thicker than prior art outer films to maximize the use of bio-based films 402 and the biodegradability of the overall package while preserving “bag feel” properties that have become so well known to consumers. Consequently, less OPP film 118 can be used than is required in the prior art, reducing consumption of fossil fuel resources. In one embodiment, the present invention provides a hybrid film having at least about one-quarter less and preferably between about one-third and one-half less fossil fuel-based carbon than a prior art film, yet comprises acceptable barrier properties. As used herein, a film having acceptable oxygen barrier properties has an oxygen transmission rate of less than about 150 cc/m²/day. As used herein, a film having acceptable moisture barrier properties comprises a water vapor transmission rate of less than about 5 grams/m²/day.

There are several advantages provided by the hybrid film depicted in FIG. 4A. First, PLA makes an excellent outer base layer. Unlike polypropylene, PLA has oxygen in the backbone of the molecule. The oxygen provides high surface energy that facilitates ink adhesion. The hybrid film uses 25% to 50% less petroleum than prior art films. The film is also partially compostable, which will be discussed in greater detail below.

FIG. 4B depicts a magnified schematic cross-section of a multi-layer packaging film made according to one embodiment of the invention. Here, the inner base layer comprises a thin metalized barrier/adhesion improving film layer 416 adjacent to a biodegradable or compostable, bio-based film 418 such as PLA instead of an oriented polypropylene 118 depicted in FIG. 1 and FIG. 4A.

A tie layer (not shown) can be disposed between the metalized barrier/adhesion improving film layer 416 and the bio-based film layer 418. A tie layer can permit potentially incompatible layers to be bonded together. The tie layer can be selected from malic anhydride, ethylenemethacrylate (“EMA”), and ethylenevinylacetate (“EVA”).

The metalized barrier/adhesion improving film layer 416 adjacent to the bio-based film 418 can be one or more polymers selected from polypropylene, an ethylene vinyl alcohol (“EVOH”) formula, polyvinyl alcohol (“PVOH”), polyethylene, polyethylene terephthalate, nylon, and a nano-composite coating.

Below depicts EVOH formulas in accordance with various embodiments of the present invention.

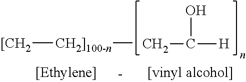

The EVOH formula used in accordance with the present invention can range from a high ethylene EVOH to a low ethylene EVOH. As used herein a high ethylene EVOH corresponds to the above formula wherein n=25. As used herein, a low ethylene EVOH corresponds to the above formula wherein n=80. Low ethylene EVOH provides oxygen barrier properties but is more difficult to process. When metalized, EVOH provides acceptable moisture barrier properties. In one embodiment, the EVOH formula can be coextruded with a bio-based film layer 418 comprising PLA and the EVOH can then be metalized by methods known in the art including vacuum deposition.

In one embodiment, the metalized barrier/adhesion improving film layer comprises a metalized amorphous polyester, APET 416 that is less than about 10 gauge and preferably between about 2 and about 4 gauge in thickness. The APET can be coextruded with the a bio-based film layer 418 comprising PLA and the APET can then be metalized by methods known in the art. In one embodiment, the metalized film 416 comprises a PVOH coating that is applied to the PLA as a liquid and then dried.

In one embodiment, one or both bio-based films 402 418 consists of only PLA. Alternatively, additives can be added to the outer base layer PLA film 402 or the barrier layer bio-based film 418 during the film making process to improve film properties such as the rate of biodegradation such as those disclosed in U.S. Patent Application Publication Number 2008/0038560 and U.S. patent application Ser. No. 12/707,368. Other optional additives that may be included in the polymer are fillers that increase the opacity of the film layer, such as titanium dioxide (TiO2).

Most biodegradable, bio-based films produced from PLA or PHA have a smooth glossy surface and appear to consumers as polymer films produced from petroleum based polymers. It is desirable for the bio-based films to have a paper-like appearance to differentiate them from prior art petroleum based polymer films. Prior art methods have made films with matte surfaces by the addition of other materials to the bio-based resins, but those methods have an increased cost associated with the required resin compounding.

It has been advantageously discovered that coextruding a surface layer of a PHBV rich resin containing about 85 to 100% PHBV onto a bio-based film to form a surface layer 404 results in an opaque, paper-like appearance with a tactile feel. In one embodiment, a resin containing about 98.5% PHBV by weight, commercially known as Tainan Y100P supplied as resin 3088, is used for the surface layer 404. The PHBV surface layer 404 may be about 0.5 to 6 microns thick, preferably about 0.5 to 4 microns. Other polymers which have a high crystallinity and stretching temperatures above that of PLA could be used to achieve the desired appearance.

Biaxially oriented PLA or PHA films prepared with surfaces of PHBV rich blends are microvoided and show significant self-cavitation without the introduction of a cavitating agent or additive. The orientation levels which produce this microvoiding are about 1.75 to about 6.0 in the machine direction (“MD”), preferably about 2.25 to about 4.0, by about 2.0 to about 6.0 in the transverse direction (“TD”), preferably about 2.5 to about 4.5. The films are cast at temperatures between about 35° C. to about 75° C., preferably between 40° C. to about 55° C. The films of the present invention are highly fibrillated and open in the thickness and in-plane directions of the film surface, i.e., the void structure is both columnar and perpendicular to the film surface. This voiding creates a reservoir for ink and prevents lateral spreading. The two-directional cavitation of the inventive film is an improvement over the calcium carbonate cavitated PLA films where the cavitation structure is clearly only in the plane of the film.

The inventive film avoids the addition of cavitation agents such as calcium carbonate, zeospheres, high density polyethylene (“HDPE”), polypropeylene (“PP”), low density polyethylene (“LDPE”), and linear low density polyethylene (“LLDPE”), which rely on the good distribution and formation of the particles in the matrix to produce cavitation. By avoiding these agents, the cavitation of the inventive film is not controlled by the formation or dispersion of the cavitating particle, which is an improvement over the prior art.

The inventive film is advantageous over prior art films as no corona or plasma treatment is necessary to achieve the desired surface energy to permit printing on the film's surface. Degradation of the inventive film is also enhanced over prior art films. Because the surface of the inventive film is microporous, a larger surface area is available for bacterial or other degradation mechanisms in the composting or biological degradation pathways.

### Example

A test with four substrates was run to compare the writing and printing performance of the inventive film to paper and other PLA films. Substrate #1 was Hewlett-Packard (“HP”) Office Paper, 20 pounds with 92 brightness for use with HP inkjet printers. Substrate #2, the inventive film, was a coextruded film with a PLA core layer, Natureworks 4060, and surfaces of resin 3088 (98.5% PHBV), biaxially oriented 2.5 MD by 3.12 TD. Substrate #3 was a coextruded film with the structure of Natureworks 4060D (PLA), Natureworks 4032D (PLA), and resin 3087 (55% PHBV and 45% Ecoflex). Substrate #4 was a coextruded film with the structure Natureworks 4060D (PLA), Natureworks 4032D (PLA), and Natureworks 4042D (PLA). Samples of each of the substrates were printed on using an inkjet printer and written on with various pens, pencils and markers to compare the quality of the printing and writing.

For the printing test, film samples of approximately six inches square were taped to the HP 20 lb paper and the same photograph was printed on each substrate by a four-color HP Officejet 6500 wireless inkjet printer using the standard inks for the printer—Officejet 920 Cyan, Magenta, Yellow and Black. The inventive film, Substrate #2, showed comparable quality to the HP printer paper with clear margins and uniform ink coverage. The inventive film sample also dried at a rate comparable to the HP paper. In contrast, Substrates #3 and #4 performed poorly, showing pooling of the ink in some areas, and failed to dry sufficiently to prevent smearing after two days.

The substrates were next written on with a Papermate Clickster with a 0.5 mm 2 HB lead pencil, a Sharpie fine point permanent marker, a blue ink Zebra F-301 ballpoint pen, and black gel ink Pilot G-2 07 fine point pen. The inventive film showed good results with all writing utensils, with the writing very readable, however, the pencil writing was slightly lighter than that on the HP paper. On Substrates #3 and #4, the pencil writing was barely visible, and both the blue and black ink writing quality was poor. The Sharpie writing gave a good sharp image on Substrate #4 but was poor on Substrate #3.

In conclusion, the inventive film, Substrate #2, performed comparably to the HP printer paper and superior to Substrates #3 and #4 in all printing and writing tests. As shown, films with the 3088 resin surface layer may be used in laminations as an outer print surface to give a paper-like appearance, feel and performance. With the addition of pigments and other additives to the inventive film, the white color balance can be controlled and the printing capability may be enhanced or optimized.

Unless otherwise indicated, all numbers expressing quantities of ingredients, properties such as molecular weight, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques.

While this invention has been particularly shown and described with reference to a preferred embodiment, it will be understood by those skilled in the art that various changes in form and detail may be made therein without departing from the spirit and scope of the invention.

What is claimed is:

1. A multi-layer packaging film comprising:
a) a surface layer comprising a biaxially oriented PHBV rich blend;
b) an outer base layer comprising a bio-based film;
c) an adhesive layer adjacent to said outer layer; and
d) a product side layer comprising barrier properties.

2. The film of claim 1 wherein said bio-based film comprises PLA or PHA.

3. The film of claim 1 wherein said PHBV rich blend comprises about 85 to 100% PHBV by weight.

4. The film of claim 1 wherein said PHBV rich blend comprises about 98.5% PHBV by weight.

5. The film of claim 1 wherein said surface layer comprises thickness of about 0.5 to 6.0 microns.

6. The film of claim 1 wherein said surface layer is biaxially oriented in the machine direction by about 2.25 to 4.0 and in the transverse direction by about 2.5 to 4.5.

7. The film of claim 1 further comprising a paper layer between said adhesive layer and said product side layer.
